(19) United States
(12) Patent Application Publication
(10) Pub. No.: US 2004/0010632 A1
(43) Pub. Date: Jan. 15, 2004

(54) System and method for dynamically adding an ioctl command to a file

(76) Inventor: Chris J. Kiick, Plano, TX (US)

Correspondence Address: HEWLETT-PACKARD COMPANY, Intellectual Property Administration, P.O. Box 272400, Fort Collins, CO, 80527-2400, US

(21) Appl. No.: 10/193,427

(22) Filed: Jul. 11, 2002

(51) Int. Cl. G06F 3/00

(52) U.S. Cl. 710/1

(57) ABSTRACT

A scheme for enabling I/O control (“ioctl”) commands to be dynamically added to and removed from a file, in particular, a pseudo device driver (“PDD”) in a Unix kernel, without requiring the kernel subsequently to be recompiled and rebooted. In one embodiment, this is accomplished by providing an ioctl table in the file for storing one or more ioctl commands. The ioctl table is indexed by ioctl command and each table entry comprises a function pointer that is called when the corresponding ioctl command is issued. Additionally, two functions are added to the PDD, including a register_cmd(cmd, fn( )) function, which adds an ioctl command (“cmd”) and its corresponding function pointer (“fn( )”)to the ioctl table, and an unregister_cmd(cmd) function, which removes an ioctl command and its corresponding function pointer from the ioctl table.

### BACKGROUND OF THE INVENTION

1. Technical Field of the Invention

The present invention generally relates to I/O control (“ioctl”) commands. More particularly, and not by way of any limitation, the present invention is directed to a system and method for dynamically adding an ioctl command to a file, in particular, a pseudo device driver in an operating system (OS) kernel.

2. Description of Related Art

A pseudo device driver is a device driver that is not connected to any physical hardware. Pseudo device drivers are used to perform various tasks within an OS kernel, e.g., a Unix kernel, and can be interfaced with using ioctl commands from user space. In general, ioctl commands run specific routines inside the kernel and return results to user space.

Conventionally, pseudo device drivers (“PDDs”) implement commands through use of a switch statement within the kernel. For each ioctl command, there is a case in the switch statement that results in the execution of a specific task, or function, for that case. The results are then returned to user space. In this scenario, to add a new ioctl command to a PDD, one must access the PDD within the kernel, add a new case to the switch statement, and recompile the kernel. Once the kernel has been rebooted, the new ioctl command can be used.

This situation is problematic for several reasons. First, because the entire kernel must be recompiled and rebooted each time an ioctl command is added to a PDD, the process is expensive, time consuming, and error-prone. Moreover, if the newly added ioctl command attempts to access code that is not present in the kernel at the time it is compiled, such as a dynamically loadable kernel module (“DLKM”), which by definition is loaded after the kernel is up and running, compilation will fail unless preventative measures are undertaken. It should be appreciated that a solution to the aforementioned deficiencies is highly desirable.

### SUMMARY OF THE INVENTION

Accordingly, an embodiment of the present invention advantageously provides a method for enabling ioctl commands to be added to and removed from a file, in particular, a PDD, in an OS kernel while the kernel is up and running without requiring the kernel subsequently to be recompiled and rebooted. In one embodiment, this is accomplished by providing an ioctl table in the file for storing one or more ioctl commands. The ioctl table is indexed by ioctl command and each table entry comprises a function pointer that is called when the corresponding ioctl command is issued. Additionally, two functions are added to the PDD, including a register_cmd(cmd, fn( )) function, which adds an ioctl command (“cmd”) and its corresponding function pointer (“fn( )”)to the ioctl table, and an unregister_cmd(cmd) function, which removes an ioctl command and its corresponding function pointer from the ioctl table.

In one aspect, an embodiment of the present invention comprises a method of dynamically adding ioctl commands to a file including the steps of providing in the file an ioctl table for storing at least one ioctl command and an associated pointer to a function to be executed when the ioctl command is issued; and adding an ioctl command and an associated function pointer to the ioctl table.

In another aspect, an embodiment of the present invention comprises a method of adding ioctl commands to a file including the steps of providing in the file an ioctl table for storing at least one ioctl command and an associated pointer to a function to be executed when the ioctl command is issued, adding a new ioctl command and an associated function pointer to the ioctl table, and subsequently removing the new ioctl command and associated function pointer from the ioctl table.

In another aspect, an embodiment of the present invention provides a system for adding ioctl commands to a file comprising an ioctl table within the file, the ioctl table for storing at least one ioctl command and an associated pointer to a function to be executed when the at least one ioctl command is issued; a register command function means within the file for adding a specified ioctl command and an associated function pointer to the ioctl table; and an unregister command function means within the file for removing a specified ioctl function and the associated function pointer from the ioctl table.

In another aspect, an embodiment of the present invention provides a system for adding ioctl commands to a file comprising means for including in the file an ioctl table for storing at least one ioctl command and an associated pointer to a function to be executed when the ioctl command is issued, and means for adding a new ioctl command and an associated function pointer to the ioctl table.

In a still further aspect, the present invention is directed to computer-accessible media having a plurality of instructions thereon, which when executed by a computer system, are operable to perform the various methods summarized hereinabove.

### BRIEF DESCRIPTION OF THE DRAWINGS

A more complete understanding of an embodiment of the present invention may be had by reference to the following Detailed Description when taken in conjunction with the accompanying drawings wherein:

FIG. 1 (Prior Art) depicts use of a switch statement within a PDD for implementing ioctl commands;

FIG. 2 depicts use of an ioctl table within a PDD for implementing ioctl commands in accordance with an embodiment of the present invention; and

FIG. 3 is a flowchart illustrating the overall steps of the method of one embodiment of the present invention.

### DETAILED DESCRIPTION OF THE DRAWINGS

In the drawings, like or similar elements are designated with identical reference numerals throughout the several views thereof, and the various elements depicted are not necessarily drawn to scale.

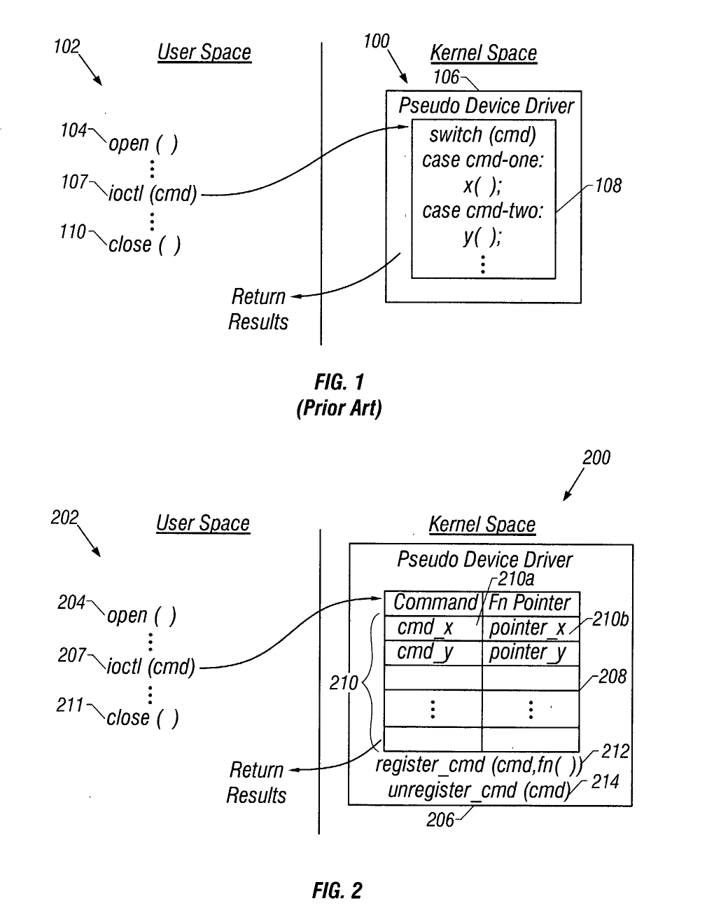

The use of a switch statement within a PDD for implementing ioctl commands in accordance with the prior art will now be described with reference to FIG. 1. As shown in FIG. 1, at some time after an OS kernel (e.g., a Unix kernel), represented in FIG. 1 as kernel space 100, has been compiled and booted, from user space 102, a user issues an open ( ) command 104 to open a PDD 106 located in kernel space 100. At that point, the user may issue an ioctl command (“ioctl (cmd)”) 107 to the PDD 106. A switch statement 108 within the PDD 106 is used to decode the ioctl command 107. The function indicated in the corresponding case of the switch statement 108 is executed and the results are returned to user space 102. At this point, when the user is finished issuing ioctl commands to the PDD 106, the PDD is closed by issuing a close( ) command 110 from user space 102.

As described above, this method described with reference to FIG. 1 is problematic in that any function called by the ioctl command must be present within the kernel at boot-up; moreover, there is no way to add and remove ioctl commands “on the fly,” that is, while the kernel is up and running without having subsequently to recompile and reboot the kernel.

Referring now to FIG. 2, therein is depicted a scheme for dynamically adding and removing ioctl commands in accordance with an embodiment of the present invention. Similar to the case illustrated in FIG. 1, at some time after the OS kernel has been compiled and booted, as represented in FIG. 2 by kernel space 200, a user can issue an open ( ) command 204 from user space 202 to open a PDD 206 located in kernel space 200. At that point, the user may issue an ioctl command (“ioctl(cmd)”) 207 to the PDD 206. In this embodiment, rather than using a switch statement, such as the switch statement 108 described above in reference to FIG. 1, the issued command is decoded using an ioctl table 208 contained within the PDD 206. Each of a plurality of entries 210 in the ioctl table 208 comprises a command 210a and a function pointer 210b. As previously indicated, the command parameter passed to the kernel space is used to index a corresponding function pointer in the ioctl table 208. Once the function pointed to by the indexed function pointer is executed, the results are returned to user space 202, at which point the PDD 206 can be closed by issuing a close( ) command 211 from user space 202.

In accordance with features of an embodiment of the present invention, the PDD 206 also includes two additional functions, including a register_cmd(cmd, fn( ))function 212 and an unregister_cmd(cmd) function 214, which respectively enable ioctl commands to be added to and deleted from the ioctl table 208. The register_cmd( ) function 212 takes as parameters an integer corresponding to the ioctl command (“cmd”) and a function pointer (“fn( )”) . The function then inserts the function pointer in the corresponding entry 210 in the table 208. The unregister_cmd( ) function 214 takes as a parameter an integer corresponding to the ioctl command and removes the function pointer from the specified entry 210 in the table 208.

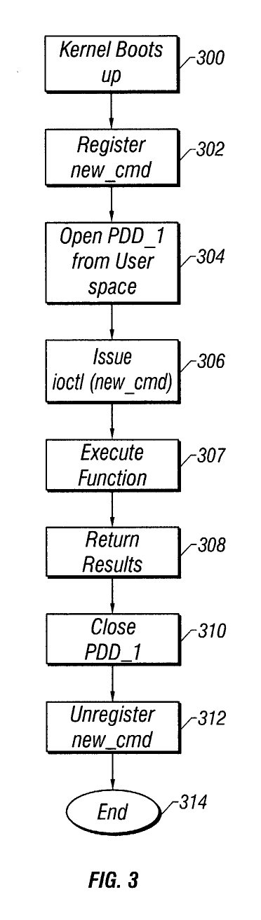

FIG. 3 depicts a flowchart of the overall operation of an embodiment of the present invention. In step 300, the kernel boots up normally. In step 302, a register_cmd( ) function is used to register an ioctl command, referred to in FIG. 3 as “new_cmd”, in connection with a particular PDD, referred to in FIG. 3 as “PDD_{—}1”. Registration of new_cmd results in the addition of the command and a function pointer (“new_fn( )) that points to a function corresponding to the command being added as an entry to the ioctl table of PDD_{—}1. In step 304, PDD_{—}1 is opened from user space. In step 306, the new_cmd is issued to PDD_{—}1. In step 307, a function pointed to by the function pointer new_fn( ) is executed and the results thereof returned to user space in step 308. In step 310, PDD 1 is closed. In step 312, the unregister_cmd function is used to remove new_cmd and new_fn( ) the ioctl table of PDD_{—}1. Execution terminates in step 314.

It should be noted that there are several ways in which the register_cmd and unregister_cmd functions can be called to add ioctl commands to and remove ioctl commands from an ioctl table within a PDD. For example, the commands may be called during the loading and subsequent unloading of a DLKM. Alternatively, they may be called during system initialization as part of the normal boot-up of the kernel or via a new system call. Additionally, the table could be edited directly by a kernel debugger with write access to kernel memory.

It should also be noted that, although as a practical matter, the inventive concepts described will be perhaps most beneficially realized when applied in connection with PDDS, the inventive principles are not limited thereto and may be applied to any type of file that can be opened or that is referenced by a file descriptor. Moreover, the inventive concepts described herein may be applied to other operating systems that make use of device files and ioctls.

A specific example of a particular use of the embodiment of the present invention described herein will now be described with respect to a Unix-based kernel (e.g., HP-UX® kernel) . For purposes of this example, it will be assumed that the Unix kernel includes an internal test interface referred to as “ktest”. As previously implemented (i.e., using a switch statement), ktest did not deal well with modular components. The embodiment of the invention described in the following example enables ktest to handle DKLM-based test modules.

In accordance with features of one embodiment of the present invention, ktest uses a table-driven interface to decode ioctl commands passed to it. As previously described, the table matches up the ioctl command with a function to call via a function pointer. The data for the ioctl command is passed directly to the function, which interprets the data for itself. In this manner, none of the existing (i.e., switch statement driven) ktest commands will need to be modified. As also previously described, two externally visible functions, i.e., “ktest_register_test( )” and “ktest_unregister_test( )”, are added for adding and removing ioctl commands to the table. The register function takes in an integer corresponding to the ioctl command and a function pointer. It then inserts the function pointer in the corresponding entry 210 in the table. The unregister function removes the function pointer from the specified entry 210 in the table.

The scenario for use of a dynamic ktest module is as follows. First, a debug kernel boots up normally, with ktest in the system file. Next, a test DLKM is loaded and, as part of the DKLM initialization, it calls ktest_register_test( ) to add a ktest command to the table. At this point, a user space test program opens /dev/ktest and uses ioctl( ) to perform its tests, after which the test program closes /dev/ktest. The test DKLM is unloaded and, as part of the unloading, ktest_unregister_test( ) is called to remove the ktest command from the table. The system is then ready for another module to be tested.

If an ioctl command is issued that does not have a valid test registered, it should return an error. If a module attempts to register a command that is already registered it should receive an error. Similarly, unregistering a nonexistent command should fail gracefully. Any currently existing ktest commands should be “reserved” and now allowed to be unregistered.

The following is sample code for implementing the above-described example:

typedef int (*ktest_test_command)(void *data);

ktest_test_command ktest_command_table[KTEST_MAX_IOCTL];

ktest_ioctl(dev_t dev, int cmd, caddr_t data)

{

if (ktest_command_table[cmd] = = NULL)

return ENXIO;
return (*ktest_command_table[cmd]) (data);

}
ktest_register(int cmd, ktest_test_command func)
{

if (cmd < KTEST_RESERVED)

return KTEST_ERR_RESERVED;

if ktest_command_table[cmd] ! = NULL

return KTEST_ERR_INUSE;

ktest_command_table[cmd] = func;

return 0;

}
ktest_unregister(int cmd)
{

if cmd < KTEST_RESERVED

return KTEST_ERR_RESERVED;

if ktest_command_table [cmd] = = NULL

return KTEST_ERR_NOENT;

ktest_command_table[cmd] = NULL;

return 0;

}

The above-described embodiment thus provides a scheme for enabling ioctl commands to be dynamically added to and removed from a PDD in a Unix kernel without requiring the kernel to be subsequently recompiled and/or rebooted.

It is believed that the operation and construction of an embodiment of the present invention will be apparent from the foregoing Detailed Description. While the system and method shown and described have been characterized as being preferred, it should be readily understood that various changes and modifications could be made therein without departing from the scope of the invention as set forth in the following claims. For example, while specific implementation examples have been described in reference to the presently preferred exemplary embodiment of the present invention involving an Unix-based kernel, such implementations are merely illustrative. Thus, the teachings of the present invention can be advantageously practiced in any OS environment that makes use of device files and ioctl commands. Moreover, the teachings of the present invention are not limited to PDDs only; rather, they may be equally applied in the context of any file that can be opened or referenced by a file descriptor from user space. Accordingly, all such modifications, extensions, variations, amendments, additions, deletions, combinations, and the like are deemed to be within the ambit of the invention whose scope is defined solely by the claims set forth hereinbelow.

What is claimed is:

1. A method of dynamically adding input/output control (ioctl) commands in a computer system, the method comprising:
providing an ioctl table in a file disposed in a kernel space executable on the computer system, the ioctl table for storing at least one ioctl command and an associated pointer to a function to be executed when the ioctl command is issued; and
adding an ioctl command and an associated function pointer to the ioctl table.

2. The method of claim 1 further comprising: including in the file a register command function.

3. The method of claim 2 wherein the register command function takes as parameters an integer corresponding to an ioctl command to be added to the ioctl table and an associated function pointer and inserts the associated function pointer in a slot in the ioctl table identified by the integer corresponding to the ioctl command to be added.

4. The method of claim 2 wherein the register command function is called during loading of a dynamically loadable kernel module (“DLKM”).

5. The method of claim 1 further comprising: removing an ioctl command and associated function pointer from the ioctl table.

6. The method of claim 5 further comprising: including in the file an unregister command function.

7. The method of claim 6 wherein the unregister command function takes as a parameter an integer corresponding to an ioctl command to be removed from the ioctl table and removes a function pointer from a slot in the ioctl table identified by the integer corresponding to the ioctl command to be removed.

8. The method of claim 6 wherein the unregister command function is called during unloading of a dynamically loadable kernel module (“DLKM”).

9. The method of claim 1 wherein the file in which the ioctl table is provided comprises a pseudo device driver.

10. A method of adding input/output control (ioctl) commands to a file, the method comprising:
including in the file an ioctl table for storing at least one ioctl command and an associated pointer to a function to be executed when the ioctl command is issued;
adding a new ioctl command and an associated function pointer to the ioctl table; and
subsequently removing the new ioctl command and associated function pointer from the ioctl table.

11. The method of claim 10 further comprising:
including in the file a register command function and an unregister command function.

12. The method of claim 11 wherein the step of adding comprises calling the register command function and the step of removing comprises calling the unregister command function.

13. The method of claim 12 wherein the register and unregister command functions are called during loading and unloading, respectively, of a dynamically loadable kernel module (“DLKM”).

14. A system for adding input/output control (ioctl) commands to a file, the system comprising:
an ioctl table within the file, the ioctl table for storing at least one ioctl command and an associated pointer to a function to be executed when the at least one ioctl command is issued;
a register command function within the file for adding a specified ioctl command and an associated function pointer to the ioctl table; and
an unregister command function within the file for removing a specified ioctl function and the associated function pointer from the ioctl table.

15. The system of claim 14 further comprising a dynamically loadable kernel module (“DLKM”) for calling the register command function to add a new ioctl command to the ioctl table and for subsequently calling the unregister command function to remove the new ioctl command from the ioctl table.

16. The system of claim 14 wherein the register command function takes as parameters an integer corresponding to an ioctl command to be added to the ioctl table and an associated function pointer and inserts the associated function pointer in a slot in the ioctl table identified by the integer.

17. The system of claim 14 wherein the unregister command function takes as a parameter an integer corresponding to an ioctl command to be removed from the ioctl table and removes a function pointer from a slot in the ioctl table identified by the integer.

18. A system for adding input/output control (ioctl) commands to a file, the system comprising:
means for including in the file an ioctl table for storing at least one ioctl command and an associated pointer to a function to be executed when the ioctl command is issued; and
means for adding a new ioctl command and an associated function pointer to the ioctl table.

19. The system of claim 18 further comprising means for subsequently removing the new ioctl command and associated function pointer from the ioctl table.

20. The system of claim 19 further comprising means for including in the file a register command function and an unregister command function.

21. The system of claim 20 wherein the register and unregister command functions are called during loading and unloading, respectively, of a dynamically loadable kernel module (“DLKM”)

22. A computer-readable medium operable with a computer to add input/output control (ioctl) commands to a file, the medium having stored thereon:
instructions executable by the computer for providing in the file an ioctl table for storing at least one ioctl command and an associated pointer to a function to be executed when the ioctl command is issued;
instructions executable by the computer for adding an ioctl command and an associated function pointer to the ioctl table; and
instructions executable by the computer for removing the ioctl command and associated function pointer from the ioctl table.

23. The computer-readable medium of claim 22 further having stored thereon instructions executable by the computer for including in the file a register command function.

24. The computer-readable medium of claim 23 wherein the register command function takes as parameters an integer corresponding to an ioctl command to be added to the ioctl table and an associated function pointer and inserts the associated function pointer in a slot in the ioctl table identified by the integer corresponding to the ioctl command to be added.

25. The computer-readable medium of claim 23 wherein the register command function is called during loading of a dynamically loadable kernel module (“DLKM”).

26. The computer-readable medium of claim 22 further having stored thereon instructions executable by the computer for including in the file an unregister command function.

27. The computer-readable medium of claim 26 wherein the unregister command function takes as a parameter an integer corresponding to an ioctl command to be removed from the ioctl table and removes a function pointer from a slot in the ioctl table identified by the integer corresponding to the ioctl command to be removed.

28. The computer-readable medium of claim 26 wherein the unregister command function is called during unloading of a dynamically loadable kernel module (“DLKM”).

29. The computer-readable medium of claim 22 wherein the ioctl table is provided in a file comprising a pseudo device driver.
